(19) United States
(12) Patent Application Publication
(10) Pub. No.: US 2020/0064877 A1
(43) Pub. Date: Feb. 27, 2020

(54) REGULATOR CONTROLLED BY SINGLE TRANSISTOR AND INTEGRATED CIRCUIT USING THE SAME

(71) Applicant: Nuvoton Technology Corporation, Hsinchu City (TW)

(72) Inventor: Yen-Hung WU, Hsinchu City (TW)

(21) Appl. No.: 16/441,178

(22) Filed: Jun. 14, 2019

(30) Foreign Application Priority Data
Aug. 24, 2018 (TW) 107129649

(51) Int. Cl. G05F 1/575

(52) U.S. Cl. CPC G05F 1/575

(57) ABSTRACT

A regulator is provided. The regulator includes a constant current source, a first transistor, a resistor, and a second transistor. The constant current source is coupled to a first node and configured to provide a bias current. The first transistor has a drain terminal coupled to the first node, a gate terminal coupled to a second node, and a source terminal. The resistor is connected in series between the source terminal of the first transistor and a ground terminal. The second transistor has a drain terminal coupled to an operation voltage node, a gate terminal coupled to the node, and a source terminal coupled to the second node. The second transistor provides an output voltage. The first transistor controls the second transistor so as to maintain a stable output voltage.

### CROSS REFERENCE TO RELATED APPLICATIONS

This Application claims priority of Taiwan Patent Application No. 107129649, filed on Aug. 24, 2018, the entirety of which is/are incorporated by reference herein.

### BACKGROUND OF THE INVENTION

### Field of the Invention

The present invention relates to a regulator, and in particular it relates to a low-dropout regulator (LDO regulator).

### Description of the Related Art

In the design of integrated circuits, it is usually required that the integrated circuits can operate over a wide range of operation voltages. However, it is difficult to maintain the circuit's characteristics under such conditions. If it is desired that designed circuits are not affected by the operation voltage, a voltage regulator is required to generate a fixed voltage for the circuits. In general, low-dropout regulators have been widely used in the design of integrated circuits because of their low noise, small size, and good conversion efficiency.

FIG. 1 is a circuit diagram of a conventional low-dropout regulator 100. Referring to FIG. 1, the low-dropout regulator 100 comprises a constant current source 101, an operational amplifier 102, a resistor R1, a bipolar transistor Q1, a power transistor M1, a voltage stabilizing capacitor C1, and a load RL. The constant current source 101, the resistor R1, and the bipolar transistor Q1 form a bandgap voltage generating circuit for providing a reference voltage V_{ref} to the negative input terminal of the operational amplifier 102. The output voltage V_{O} is fed back to the positive input of the operational amplifier 102 (represented by V_{FB}). The operational amplifier 102 operates as a comparator to compare the reference voltage V_{ref} and the output voltage V_{O} and amplify the difference therebetween. The output terminal of the operational amplifier 102 is coupled to the gate of the power transistor M1. The power transistor M1 is a P-type metal-oxide-semiconductor field-effect transistor (MOSFET). The source of the power transistor M1 is coupled to the operation voltage VDD, and the drain thereof is coupled to the output voltage Vo for driving the subsequent load RL. When the operation voltage VDD of the power transistor M1 or the output voltage V_{O} is changed, the output voltage V_{O} is fed back to the operational amplifier 102, and then the operational amplifier 102 controls the gate of the power transistor M1 to generate a stable output voltage V_{O}.

However, the conventional low-dropout regulator 100 uses an operational amplifier 102, which consumes a lot of power. Moreover, the bandgap voltage generating circuit must use a bipolar transistor Q1 for outputting a precise reference voltage, although the bipolar transistor takes up a lot of space.

### BRIEF SUMMARY OF THE INVENTION

The present invention provides a regulator that does not use an operational amplifier. This invention has the characteristics of low power consumption and a small area, which is appropriate for circuits that require voltage regulation but do not induce much extra current consumption and occupied area. The regulator provided by the present invention appropriately serves as a power source for local analog circuit blocks in integrated circuits.

An exemplary embodiment of a regulator comprises a constant current source, a first transistor, a resistor, and a second transistor. The constant current source is coupled to a first node and configured to provide a bias current. The first transistor has a drain terminal coupled to the first node, a gate terminal coupled to a second node, and a source terminal. The resistor is connected in series between the source terminal of the first transistor and a ground terminal. The second transistor has a drain terminal coupled to an operation voltage node, a gate terminal coupled to the first node, and a source terminal coupled to the second node and configured to provide an output voltage. The first transistor controls the second transistor so as to maintain a stable output voltage.

In an embodiment, the first transistor and the second transistor are N-type MOS field-effect transistors.

In another embodiment, the output voltage is equal to a gate-source voltage (V_{GS}) of the first transistor plus a voltage drop of the resistor, and the gate-source voltage of the first transistor is determined by the bias current.

In another embodiment, the voltage of the first node may be adjusted by feeding back the output voltage to the gate terminal of the first transistor to control the gate terminal of the second transistor, so that the output voltage remains stable and is not affected by a change of the operation voltage.

In another embodiment, the gate-source voltage of the first transistor has a negative temperature coefficient and decreases as temperature rises, the constant current source has a positive temperature coefficient, and the voltage drop of the resistor increases as the temperature rises, such that the output voltage is not affected by change of the operation voltage.

In another embodiment, the output voltage is output to a load circuit, and the logic circuit can be a logic circuit, a phase-locked loop, a bias circuit, an oscillator, or a combination thereof.

In another embodiment, the second transistor is a power transistor.

In another embodiment, the regulator is a low-dropout regulator integrated in an integrated circuit.

An exemplary embodiment of an integrated circuit comprises at least one function block. The function block comprises the above regulator. The regulator provides a stable output voltage to the function block.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a circuit diagram of a conventional low-dropout regulator;

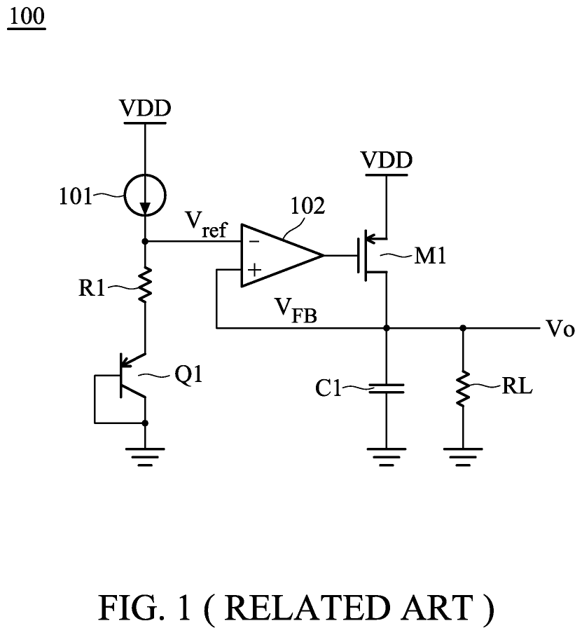

FIG. 2 is a circuit diagram of a regulator according to an embodiment of the present invention;

FIG. 3A is a schematic diagram showing changes in temperature of a regulator according to an embodiment of the present invention;

FIG. 3B is a schematic diagram showing changes in an operation voltage of a regulator according to an embodiment of the present invention; and

FIG. 4 is a schematic diagram showing an integrated circuit according to an embodiment of the present invention.

### DETAILED DESCRIPTION OF THE INVENTION

In order to make the above and other objects, features and advantages more clear and easy to understand, the preferred embodiments are set forth in the accompanying drawings. The detail will be described in the following.

It is to be understood that the following disclosure provides one or more embodiments or examples to implement various features of the invention. The elements and arrangements of the specific examples disclosed below are intended to simplify the invention, and are not intended to limit the invention. In addition, the features in the drawings are not drawn in proportion and are for illustrative purposes only.

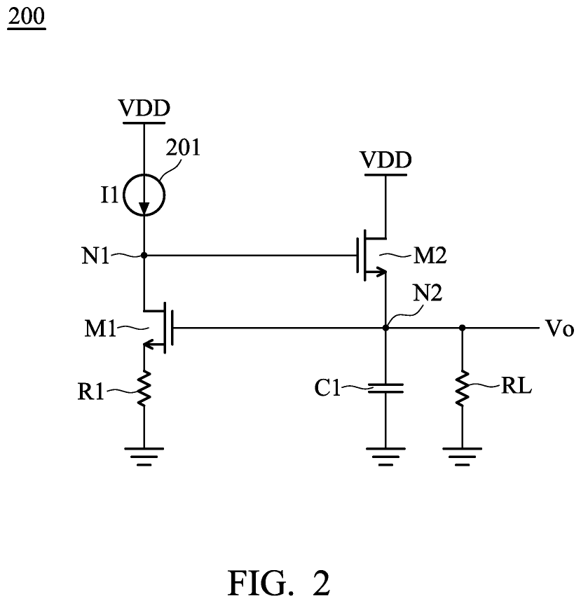

FIG. 2 is a circuit diagram of a regulator 200 according to an embodiment of the present invention. The regulator 200 comprises a constant current source 201, a first transistor M1, a second transistor M2, and a resistor R1. The constant current source 201 can be implemented by a constant-gm bias circuit coupled to an operation voltage node and a first node N1 and configured to provide a constant bias current I1. The operation voltage node is coupled to the operation voltage VDD. The constant current source 201 may also be a bias current provided by another analog circuit, however, the present invention is not limited thereto.

The first transistor M1 and the second transistor M2 are all N-type MOS (metal-oxide-semiconductor, MOS) field-effect transistors, wherein the second transistor M2 serves as a power transistor which supplies voltage and current required for the load. The power transistor has the characteristics of high voltage endurance, high current endurance, and low on-resistance. The first transistor M1 has a drain terminal, a source terminal, and a gate terminal. The drain terminal of the first transistor M1 is coupled to the first node N1. The gate terminal of the first transistor M1 is coupled to a second node N2. The resistor R1 is connected in series between the source terminal of the first transistor M1 and a ground terminal.

The second transistor M2 has a drain terminal, a source terminal, and a gate terminal. The drain terminal of the second transistor M2 is coupled to the operation voltage node. The gate terminal of the second transistor M2 is coupled to the first node N1. The source terminal of the second transistor M2 is coupled to the second node N2 and configured to provide an output voltage V_{O} to the load RL for use by the circuit of the load RL. The first transistor M1 controls the second transistor M2 to keep the output voltage V_{O} stable. The detailed principles will be described later. In addition, the regulator 200 may alternatively comprise an output capacitor C1, however, the invention is not limited thereto. The output capacitor C1 provides the effect of noise filtering and voltage regulation.

In the regulator 200 of FIG. 2, the first transistor M1 replaces the operational amplifier of the conventional low-dropout regulator and serves as a comparator, and a reference voltage is generated by the first transistor M1 and the resistor R1. The reference voltage can be determined by determining the constant bias current I1 of the constant current source 201 and the resistance value of the resistor R1. As shown in FIG. 2, the output voltage V_{O} of the second node N2 is equal to the gate-source voltage (VGS) of the first transistor M1 plus the voltage drop of the resistor R1 (V_{O}=I1×R1+V_{GS}). The gate-source voltage (VGS) of the first transistor M1 is determined by the bias current I1. In a condition that the first transistor M1 operates in the saturation region, the drain current ID can be expressed by the following formula (1) without considering the channel length modulation effect.

$${I}_{D} = \frac{μ {C}_{ox}}{2} \frac{W}{L} {( {V}_{GS} - {V}_{th} )}^{2} \qquad ( 1 )$$

Where μ is the carrier mobility; Cₒₓ is the unit capacitance of the gate oxide layer; W is the gate width; L is the gate length; V_{GS} is the gate-source voltage; Vₜₕ is the threshold voltage.

In the present invention, the constant current source 201 is used to provide the constant bias current I1, so the drain current of the first transistor M1 is equal to the bias current I1. According to the above formula (1), once the bias current I1 is determined, the gate-source voltage (VGS) of the first transistor M1 is also determined.

It is worth noting that the output voltage V_{O} of the regulator 200 is determined by the gate-source voltage of the first transistor M1 plus the voltage drop of the resistor R1, and the output voltage V_{O} is simultaneously fed back to the gate terminal of the first transistor M1. Such a connection means that when the operation voltage VDD or the output voltage V_{O} changes, the gate voltage of the first transistor M1 is adjusted, so that the current flowing through the resistor R1 is changed, thereby adjusting the voltage of the first node N1. Since voltage of the first node N1 controls the gate terminal of the second transistor M2, the conduction current of the second transistor M2 is changed in response to the change of the voltage of the first node N1, thereby regulating the output voltage V_{O}, so that the output voltage V_{O} remains stable and is not affected by the change of the operation voltage VDD.

For example, when the output voltage V_{O} of the second node N2 decreases, the gate voltage fed back to the first transistor M1 also decreases, and the current flowing through the resistor R1 decreases, so that the voltage of the first node N1 increases. Then, the voltage of the gate terminal of the second transistor M2 rises, so that the on-current of the second transistor M2 rises. Accordingly, the output voltage V_{O} is pulled back to the original voltage level eventually. In contrast, when the output voltage V_{O} of the second node N2 increases, the gate voltage fed back to the first transistor M1 also increases, and the current flowing through the resistor R1 increases, so that the voltage of the first node N1 decreases. Eventually, the output voltage Vo is pulled back to the original voltage level. Therefore, with the above circuit configuration, the influence of the operation voltage VDD on the output voltage V_{O} can be eliminated.

In addition, the output voltage V_{O} of the regulator 200 also has characteristics that are not affected by changes in ambient temperature. In general, the threshold gate-source voltage of an N-type MOS field-effect transistor has a negative temperature coefficient in which the threshold voltage decreases as the temperature rises. Considering that in cases where the drain current is constant, such as when the gate-source voltage approaches the threshold voltage, the gate-source voltage of the N-type MOS field-effect transistor decreases as the temperature rises. In the regulator 200 of FIG. 2, the gate-source voltage of the first transistor M1 decreases as the temperature rises.

In order to counteract the influence of the temperature change on the output voltage V_{O}, a constant current source 201 with a positive temperature coefficient is used, and the bias current I1 of the constant current source 201 increases as the temperature rises, so that the voltage drop of the resistor R1 increases as the temperature rises. As described above, the output voltage V_{O} of the second node N2 is equal to the gate-source voltage of the first transistor M1 plus the voltage drop of the resistor R1. Thus, using such a configuration, the output voltage Vo is not affected by the temperature change.

Furthermore, the output voltage V_{O} of the regulator 200 is output to a load circuit. The load circuit can be one of various circuits, such as a logic circuit, a phase-locked loop (PLL), a bias circuit, an oscillator, or a combination thereof. In an embodiment, the regulator 200 can be a low dropout voltage regulator integrated in an integrated circuit.

It is worth noting that in the regulator 200, the reason that an N-type MOS field-effect transistor (NMOS) is used as the power transistor is that compared to a P-type MOS field-effect transistor (PMOS), the N-type MOS field-effect transistor has a strong driving capability, so it takes up only half of the area, and the NMOS power transistor responds faster than a PMOS transistor when the current of the load RL changes. Therefore, compared to conventional low-dropout regulators, the regulator 200 provided by the present invention has the advantages of a small area, fast response speed, and easy compensation, and it is suitable for an individual function block with voltage regulation requirements in the integrated circuit.

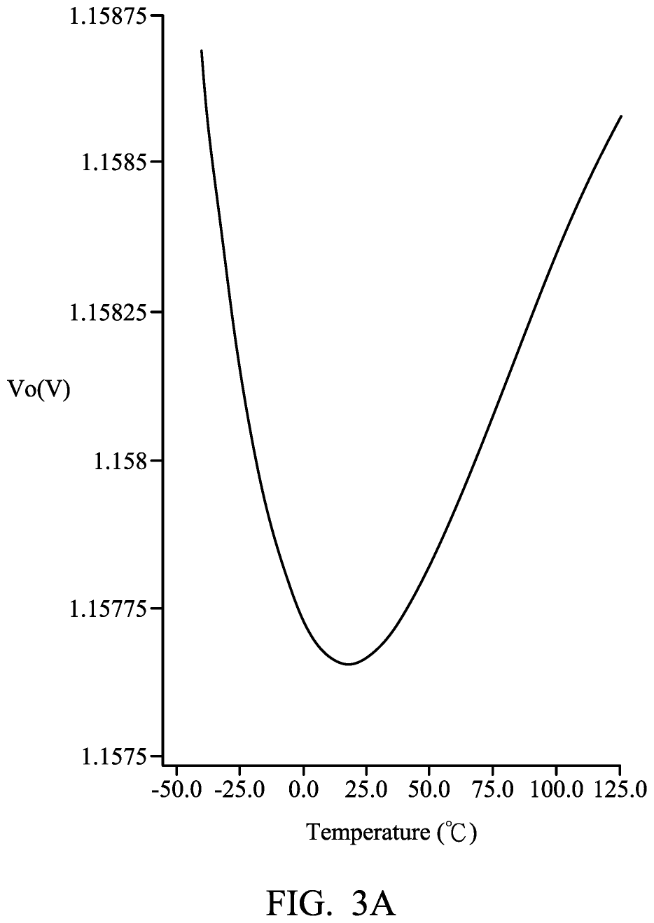

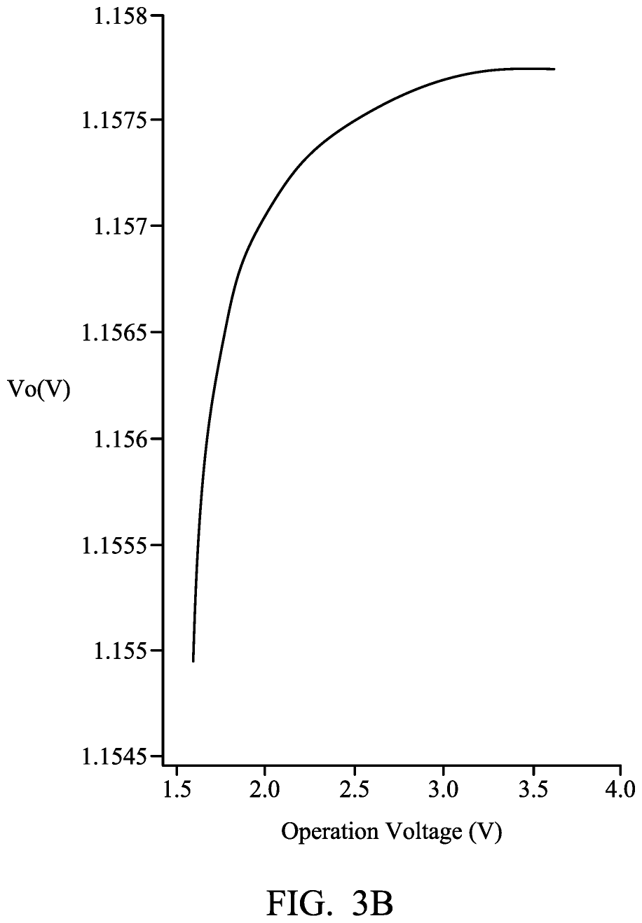

Referring to FIGS. 3A and 3B, FIG. 3A is a schematic diagram showing changes in the temperature of the regulator 200 according to an embodiment of the present invention. FIG. 3B is a schematic diagram showing changes in the operation voltage of the regulator 200 according to an embodiment of the present invention. As shown in FIG. 3A, as the temperature changes, the output voltage V_{O} of the regulator 200 is hardly affected by the temperature, and it remains stable. The simulation range of the ambient temperature is about −40° C. to 125° C. It can be seen in FIG. 3A that the output voltage V_{O} is maintained at near 1.158 V even under a wide range of ambient temperature variations. The range of the variation of the output voltage V_{O} is considerably small. In FIG. 3A, the horizontal axis is the temperature in ° C., and the vertical axis is the output voltage Vo in volts.

FIG. 3B shows that, when the operation voltage is changed, the output voltage V_{O} of the regulator 200 hardly changes due to the influence of the operation voltage. The simulation range of the operation voltage is from about 1.6V to 3.6V, which is the more commonly used specification voltage in integrated circuits. It can be seen in FIG. 3B that the output voltage Vo is maintained around 1.156V even under a wide range of operation voltage variations. The range of the variation of the output voltage V_{O} is also relatively small. In FIG. 3B, the horizontal axis is the operation voltage in volts, and the vertical axis is the output voltage V_{O} in volts. Therefore, the regulator 200 can maintain an approximately constant output voltage V_{O} at different temperatures and operation voltages.

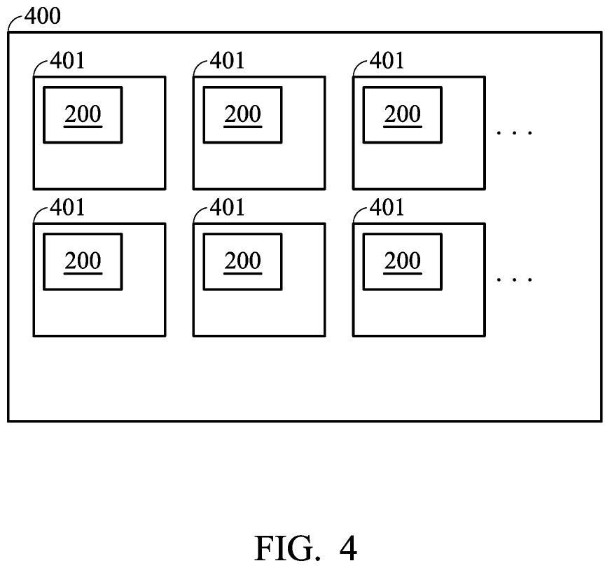

FIG. 4 is a schematic diagram showing an integrated circuit 400 according to an embodiment of the present invention. In FIG. 4, the integrated circuit 400 comprises at least one function block 401, and each function block 401 has a regulator 200 as shown in FIG. 2. The regulator 200 provides a stable output voltage to the circuits of each function block 401. The function block 401 may be one of various digital or analog circuits of a silicon intellectual property, such as a logic circuit, a phase locked loop, a bias circuit, an oscillator, or a combination thereof, however, the present invention is not limited thereto.

As described above, the present invention provides a regulator and an integrated circuit having a regulator. The regulator provided by the invention can achieve the required voltage regulation by using the most compact circuit architecture. The regulation control can be completed by using only one N-type MOS field-effect transistor and one resistor, and no external reference voltage is needed. Compared with conventional low-dropout regulators, the regulator of the present invention uses an N-type MOS field-effect transistor to replace the operational amplifier and serve as a comparator. Since the regulator of the present invention does not use an operational amplifier, power savings can be achieved. Moreover, the circuit structure of the regulator of the present invention is simple, the compensation for the stability is also easier than that of conventional low-dropout regulators. Thus, the regulator of the present invention has the advantages of area saving, fast response, easy compensation, and is suitable for individual function blocks in an integrated circuit.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A regulator comprising:
a constant current source, coupled to a first node and configured to provide a bias current;
a first transistor having a drain terminal coupled to the first node, a gate terminal coupled to a second node, and a source terminal;
a resistor connected in series between the source terminal of the first transistor and a ground terminal; and
a second transistor having a drain terminal coupled to an operation voltage node, a gate terminal coupled to the first node, and a source terminal coupled to the second node and configured to provide an output voltage,
wherein the first transistor controls the second transistor so as to keep the output voltage stable.

2. The regulator as claimed in claim 1, wherein the first transistor and the second transistor are N-type MOS field-effect transistors.

3. The regulator as claimed in claim 1, wherein the output voltage is equal to a gate-source voltage (V_{GS}) of the first transistor plus a voltage drop of the resistor, and the gate-source voltage of the first transistor is determined by the bias current.

4. The regulator as claimed in claim 3, wherein a voltage of the first node is adjusted by feeding back the output voltage to the gate terminal of the first transistor to control the gate terminal of the second transistor, so that the output voltage remains stable and is not affected by a change of the operation voltage.

5. The regulator as claimed in claim 3, wherein the gate-source voltage of the first transistor has a negative temperature coefficient and decreases as temperature rises, the constant current source has a positive temperature coefficient, and the voltage drop of the resistor increases as the temperature rises, so that the output voltage is not affected by change of the operation voltage.

6. The regulator as claimed in claim 1, wherein the output voltage is output to a load circuit, and the logic circuit is a logic circuit, a phase-locked loop, a bias circuit, an oscillator, or a combination thereof.

7. The regulator as claimed in claim 1, wherein the second transistor is a power transistor.

8. The regulator as claimed in claim 1, wherein the regulator is a low-dropout regulator integrated in an integrated circuit.

9. An integrated circuit comprising:
at least one function block, wherein the at least one function block comprises the regulator claimed in claim 1, and the regulator provides a stable output voltage to the at least one function block.

10. The integrated circuit as claimed in claim 9, wherein the function block is a logic circuit, a phase locked loop, a bias circuit, an oscillator, or a combination thereof.
